(19) United States
(12) Patent Application Publication
(10) Pub. No.: US 2015/0257614 A1
(43) Pub. Date: Sep. 17, 2015

(54) Potty Training Educational System

(71) Applicant: Linfred Longenecker, South Bend, IN (US)

(72) Inventor: Linfred Longenecker, South Bend, IN (US)

(21) Appl. No.: 14/726,953

(22) Filed: Jun. 1, 2015

Related U.S. Application Data
(63) Continuation-in-part of application No. 14/099,223, filed on Dec. 6, 2013.
(60) Provisional application No. 62/006,516, filed on Jun. 2, 2014.
(60) Provisional application No. 61/735,219, filed on Dec. 10, 2012.

(51) Int. Cl. A47K 11/00; G09B 19/00

(52) U.S. Cl. CPC A47K 11/00; G09B 19/0076

(57) ABSTRACT

Apparatuses and methods for a potty training system. In embodiments, the potty training system includes a model toilet including a flushing mechanism. Fluids may be poured into the toilet bowl and drained by pressing the designated button, which causes the valve seal to break and empty the toilet bowl, and the contents drain out in a process modeling a functional toilet. Used in this manner, the potty training system may be operated by a younger child in the bathtub to create a positive association between the toy training system and a functional toilet.

### CROSS-REFERENCE TO RELATED APPLICATIONS

This application is a continuation-in-part of U.S. Nonprovisional application Ser. No. 14/099,223, which claimed priority from U.S. Provisional Application No. 61/735,219, and is hereby incorporated in its entirety by reference, and claims priority from U.S. Provisional Application No. 62/006,516, the disclosure of which is hereby incorporated in its entirety by reference.

### BACKGROUND

Generally, potty training of a child is reserved for late toddler years and more advanced ages when a child is physically capable of using a standard toilet. Consequently, young children are not acclimated to the use and purpose of a toilet. Some children may be unwilling to use a toilet, either out of fear or because they fail to recognize any purpose or benefit to doing so. Parents employ various methods to provide incentives for children to use the toilet, and many also seek potty training aids from a variety of forms such as, potty chairs and related devices, books and DVDs, and toys. While the existence of such aids has somewhat helped ease the general challenges for parents in the potty training process, there remains a need for tools to facilitate early potty training.

Many tools and apparatuses exist to aid in the training of a child that is physically ready to use a toilet. Examples range from training pants to easier-to-use, especially-designed flushless toilets to acclimate a child to using a toilet. While these devices are valuable in training a child to use an actual toilet, they are designed to be of use for a child that is physically ready to use a toilet and are not meant to aid a younger child in becoming comfortable and familiar with the purpose and function of a toilet.

### BRIEF SUMMARY

The following presents a simplified summary in order to provide a basic understanding of some aspects of the claimed subject matter. This summary is not an extensive overview. It is not intended to either identify key or critical elements or to delineate the scope of the claimed subject matter. Its sole purpose is to present some concepts in a simplified form as a prelude to the more detailed description that is presented later.

The described apparatuses and methods provide a functional toy that can be used to acclimate a younger child to the purpose and functionality of toilets. By familiarizing a younger child with the process and functioning of a toilet, they can feel more comfortable, confident, and able to use a proper toilet when they are physically ready to begin toilet training.

The described apparatuses provide a novel, functional toy or model toilet for easy use by small children in the early stages of toilet training. The model toilet can be used as a component of a potty training system for children to use through the toilet training process and may be used to help aide a child to understand the function of a toilet and to associate a toilet with urination. In one embodiment, the toilet includes a flushing mechanism comprised of a top-facing button that is depressed to “flush” the model toilet. The depression of the button causes an attached, vertically-oriented rod to be pushed downward against the force of attached restoring springs. In embodiments, the vertically-oriented rod is in a fixed, perpendicular position to a horizontally-running stem that is attached at the base of the vertical rod via male-to-female fasteners at the end of each connecting rod. At the opposite end of the horizontal stem is a valve, for example a diaphragm-type, convex-side-up valve. In the default position, this valve seals the drain of the toilet bowl through the force of the aforementioned springs. When the button is depressed, the valve and rods are lowered, breaking the seal of the toilet bowl drain, and emptying the contents of the toy toilet to simulate the functioning of a full-size toilet. This action enables a small child to grasp the purpose and use of a toilet at a scale and in a context that is less threatening and intimidating than a full-size toilet. In embodiments, the flushing mechanism is partially or entirely enclosed within the shell of the toy toilet to prevent pinching of the child and potential obstructions from interfering with the motion of the mechanism.

A model toilet for use in potty training, comprising a model toilet bowl having an aperture at about the bottom of the bowl, and a flushing mechanism that includes a valve that seals the aperture of the model toilet bowl, and a button functionally connected to the valve, wherein pressure applied to the button is directed to open the valve. The model toilet also comprises a shell that supports the model toilet bowl and covers at least a portion of the flushing mechanism and at least one suction cup connected to the shell that removably attaches to a surface to suspend the model toilet.

In embodiments, the shell comprises a back portion that generally models the shape of a tank of a functional toilet; and a base portion that supports the model toilet bowl and connects to the back portion. In other embodiments, at least a portion of the base portion is open at the bottom to allow liquid to drain from the bowl through the aperture in the model toilet bowl and through the base portion out of the model toilet.

A potty training system, comprising a model toilet and a doll. The model toilet comprising a model toilet bowl having an aperture at about the bottom of the bowl and a flushing mechanism that comprises a valve that seals the aperture of the model toilet bowl and a button functionally connected to the valve; wherein pressure applied to the button is directed to open the valve. The model toilet also comprises a shell that supports the model toilet bowl and covers at least a portion of the flushing mechanism. The doll is sized and shaped for use with the model toilet, wherein the doll is adapted to simulate urination by squirting liquid into the model toilet, and the flushing mechanism operates to drain the liquid from the model toilet bowl and out the bottom of the model toilet.

A potty training system, comprising a doll and a model toilet. The model toilet, comprising a model toilet bowl having an aperture at about the bottom of the bowl and a flushing mechanism that comprises a valve that seals the aperture of the model toilet bowl, and a button functionally connected to the valve; wherein pressure applied to the button is directed to open the valve. The model toilet also comprises a shell that supports the model toilet bowl and covers at least a portion of the flushing mechanism, wherein the shell comprises a back portion that generally models a tank of a functional toilet and a base portion that supports the model toilet bowl and connects to the back portion, and at least one suction cup connected to the shell that removably attaches to a surface to suspend the model toilet. The doll is sized and shaped for use with the model toilet, wherein the doll is adapted to simulate urination by squirting liquid into the model toilet, and the flushing mechanism operates to drain the liquid from the model toilet bowl.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

The systems, devices and methods may be better understood by referring to the following description in conjunction with the accompanying drawings, in which like numerals indicate like structural elements and features in various figures. The components in the figures are not necessarily to scale, and simply illustrate the principles of the systems, devices and methods. The accompanying drawings illustrate only possible embodiments of the systems, devices and methods and are therefore not to be considered limiting in scope. In particular, dimensions, materials, colors and weights noted on the drawings are solely for an example embodiment and are not limiting.

FIG. 1 is a perspective view of an embodiment of a potty training system.

FIG. 2 is a side view of an embodiment of a doll for use with the potty training system depicted in FIG. 1.

FIG. 3 is a front view of an embodiment of the doll for use with the potty training system depicted in FIG. 1.

FIG. 4 depicts a perspective view of an embodiment of a model toilet that can be used with a potty training system.

FIG. 5 depicts a side view of an embodiment of a model toilet training device that can be used with a potty training system.

FIG. 6 depicts a front view of an embodiment of a model toilet training device that can be used with a potty training system.

FIG. 7 depicts a back view of an embodiment of a model toilet training device that can be used with a potty training system.

FIG. 8 depicts a top view of an embodiment of a model toilet training device that can be used with a potty training system.

FIG. 9 depicts a bottom view of an embodiment of a model toilet training device that can be used with a potty training system.

FIG. 10 depicts a cut-away view of an embodiment of a model toilet training device that can be used with a potty training system.

FIG. 11 depicts an exploded view of an embodiment of a potty training system.

FIG. 12 depicts a bottom view of an embodiment of a model toilet training device that can be used with a potty training system.

FIG. 13 depicts a perspective view of an embodiment of protective screen for a model toilet training device that can be used with a potty training system.

FIG. 14 depicts a perspective view of an embodiment of a flushing mechanism for a model toilet training device that can be used with a potty training system.

### DETAILED DESCRIPTION

Aspects of the potty training apparatuses and methods are described below with reference to illustrative embodiments. The references to illustrative embodiments below are not made to limit the scope of the claimed subject matter. Instead, illustrative embodiments are used to aid in the description of various aspects of the systems and methods. The description, made by way of example and reference to illustrative reference, is not meant to being limiting as regards any aspect of the claimed subject matter.

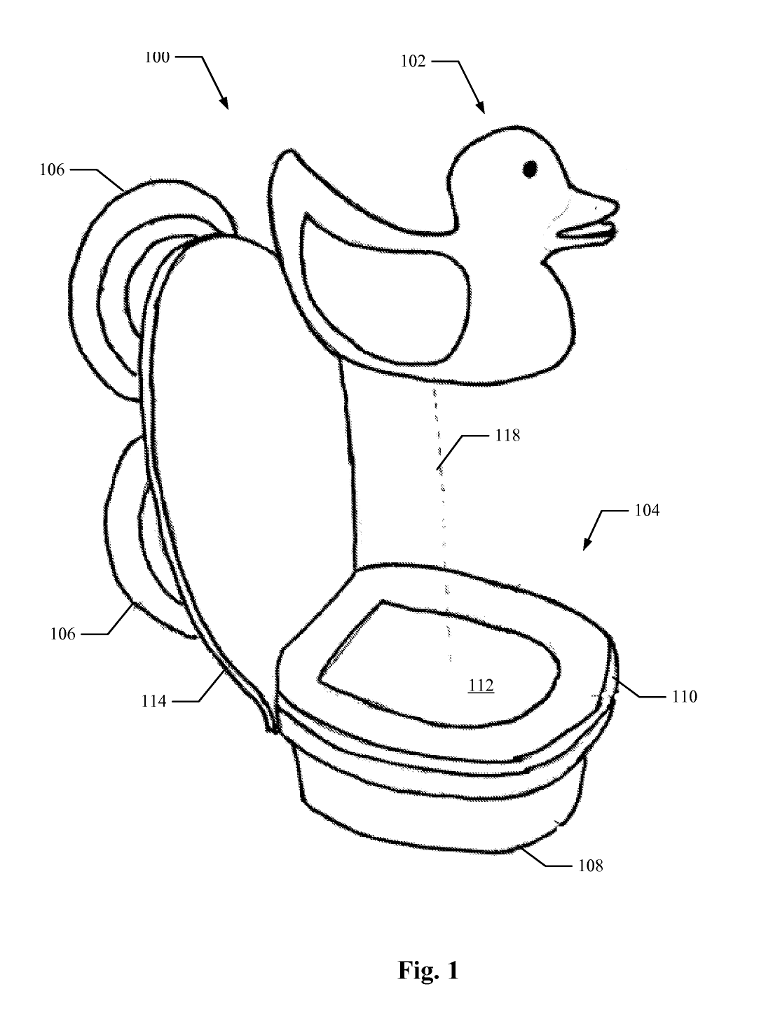

With reference to FIG. 1, an embodiment of a potty training system 100 is illustrated. In one embodiment, the potty training system 100 includes an animal-shaped doll 102 and a model toilet 104. The doll 102 and the model toilet 104 can be used to demonstrate proper toilet use and introduce potty training to a child in a positive way. The potty training system 100 may be used as a potty training tool, a toy for children, or both. It is an important goal of potty training that children associate the act of urination with a toilet and using the potty training system 100 will help a child make that association.

In one embodiment, the animal-shaped doll 102 is capable of releasing liquid 118 into the model toilet 104. It is intended that the child, or adult interacting with the child, position the animal-shaped doll 102 roughly centered over the top of the model toilet 104. When the liquid 118 is released from the animal-shaped doll 102, the liquid 118 enters the model toilet 104 and resembles urination into a functioning toilet. In embodiments, the doll 102 is sized and shaped so that it can be easily grasped by a small child, allowing the child to take an active role in the play and training. The doll 102 and model toilet 104 used in this way are a non-threatening and non-intimidating way to introduce children to potty training.

In one embodiment the potty training system 100 is used in the bathtub. The doll 102 and model toilet 104 can be formed from materials conducive to bathtub play, such as rubber, plastic or other non-porous, quick-drying materials. In addition to the bathtub, the child may use the potty training system 100 in any convenient location such as a sink, shower, pool, or plastic tub. The use of the potty training system 100 in the bathtub may be beneficial as the water is contained within the bathtub, or at least the bathroom, aiding cleanup. Additionally, the bathtub is a fun environment for a child and using the potty training system 100 in the bathtub may create a positive association with the potty training system 100, alleviating some of the pressures of potty training and encouraging the child.

In embodiments, the doll 102 is elastic and compressible and may be shaped like an animal. In one embodiment, the doll 102 may be shaped like a duck, as shown. However, the doll 102 may take the shape of any animal. As used herein, the term “doll” encompasses a wide range of figures, including but not limited to, representations of humans, animals, anthropomorphized animals, cartoons, mythical creatures, and the like. For example, the doll 102 can be shaped like a mythical creature (e.g., a unicorn), cartoon animal (e.g., Winnie-the-Pooh or Mickey Mouse) or may even take the shape of a human being. The doll 102 may be any shape that would encourage the child to use the potty training system 100 as a toy. The doll 102 may also take a shape with which the child would identify or seek to emulate, such as a favorite character from a television show or book. The doll 102 may be sized proportionally to the model toilet 104, such that the child associates the two together. In embodiments, the doll 102 is sized and shaped to be grasped easily by a toddler, such that the child is able to manipulate and play with the potty training system 100. However, it is understood that the doll 102 may take any size and any shape.

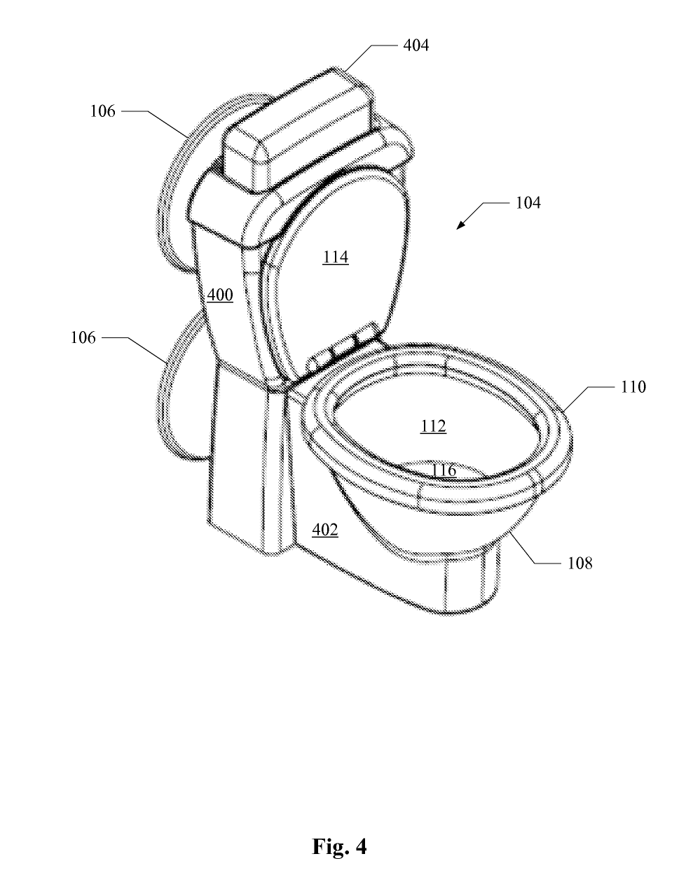

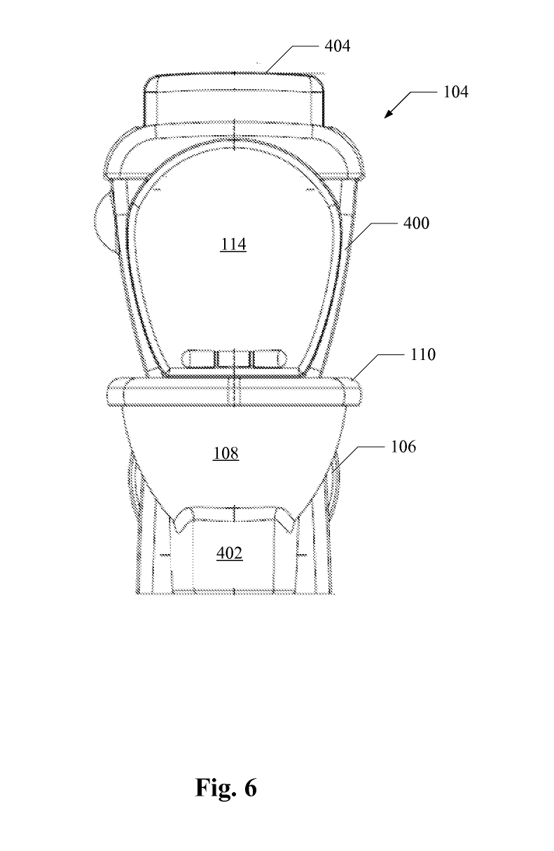

In embodiments, the model toilet 104 is shaped similar to a functioning toilet and may be comprised of scaled models of several of the elements of a functioning toilet. For example, as depicted in FIG. 1, the model toilet 104 can include a toilet seat 110 and a toilet bowl 108 with a bowl interior 112. In an embodiment, the toilet model 104 can also include a lid 114, with one or more suction cups 106 attached to the back of the lid 114. It is contemplated that the suction cups 106 allow the model toilet 104 to be attached to a surface such as a bathtub or tile wall, so that the toilet model 104 is held in place while the child plays with the doll 102. The model toilet 104 may be proportionally sized to the doll 102. However, it is understood that the model toilet 104 may take any size and any shape. In embodiments, the model toilet 104 is approximately five inches in length, from the back of the suction cups 106 to the front of the toilet seat 110, and approximately three inches in width. The model toilet 104 can be approximate 5.25 inches in height. Embodiments of the model toilet 104 are described in detail below with respect to FIGS. 4-9.

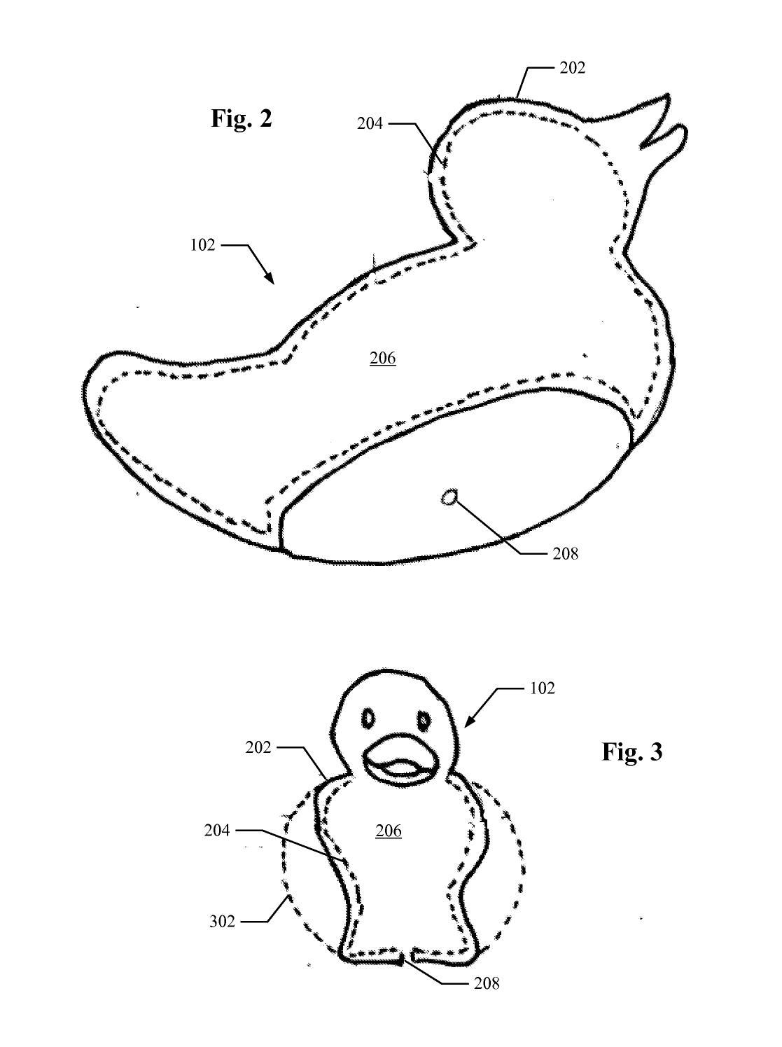

With reference to FIG. 2, an embodiment of the doll 102 is illustrated. In one embodiment, the structure of the doll 102 has an exterior surface 202 and an interior surface 204. The distance between the external surface 202 and internal surface 204 may vary. In embodiments, the thickness of the doll 102 between the external surface 202, and internal surface 204, and material from which the doll 102 is formed, are such that a small child would be capable of squeezing the doll 102 and deforming the doll 102 to compress the interior of the doll 102. This would allow the child to use the potty training system 100 on his or her own without the aid of an adult, which would encourage the child to be an active participant in potty training. In another aspect of this embodiment, the doll has an internal compartment 206 that holds the fluid. As used herein, the term “fluid” means a liquid or a gas. When the doll 102 is compressed, the internal surface 204 will collapse and the volume of the internal compartment 206 will correspondingly be decreased, forcing the fluid from the aperture 208.

In embodiments, the doll has an aperture 208 creating an egress through the external surface 202 and the internal surface 204 as well as between the exterior of the doll 102 and the internal compartment 206 of the doll 102. In an embodiment, the aperture 208 is positioned near the bottom center of the doll 102. However, it is understood that the aperture 208 may be positioned anywhere on the doll 102. While a single aperture 208 is illustrated, there may also be more than one aperture 208 on the doll 102. In one embodiment the aperture 208 is annular. However, in other embodiments the aperture 208 may be any suitable shape. For example, the aperture can be a slit, such that when the doll 102 is compressed, the elastic nature of the doll opens the aperture 208, and when the doll 102 is released, the aperture 208 effectively closes, as the sides of the slit abut one another and hold the fluid in place. In embodiments, the aperture 208 may be sized or shaped such that when the interior compartment is filled with fluid, the fluid is held within the internal compartment 206, and either does not leak or leaks minimally by the force of gravity alone. The aperture 208 may also be sized or shaped and configured to make a squirt or a squeaking sound when air is released from the doll 102.

With reference to FIG. 3, an embodiment of the doll 102 is illustrated as compressed. The doll 102, shown as a duck, is compressed when a child or parent pushes the exterior surface 202 inward towards the center of the doll 102. The doll 102 may be sized and configured such that it is easily used by a child. Upon compression of the doll 102, the interior surface 204 will move in relation to the exterior surface 202. It is contemplated that the compression of the doll 102 will decrease the volume of the internal compartment 206. Consequently, the fluid within the internal compartment 206 will be released through the aperture 208. Depending on the fluid within the internal compartment 206, either gas or liquid, and the size and configuration of the aperture 208, the fluid may be released in a squeaking nature or a squirting nature. It is also contemplated the fluid may simply pass through the aperture 208. Upon the termination of the compressive force on the doll 102, the elastic nature of the doll 102 will cause it to return to its initial shape 302. As the doll 102 returns to its initial shape 302, the volume of the internal compartment 206 will increase, returning to its initial size and shape. As the internal compartment 206 increases, it will create a suction effect through the aperture 208 and the fluid, whether liquid or gas, in the external environment will be sucked into the internal compartment 206.

The doll 102 can be used to simulate urination through compression of the body of the doll 102. In one embodiment a child may compress the body of the doll 102 to release the liquid within the internal compartment 206. The child may then place the doll 102, in the compressed position, into a liquid such as water. As the compressive force is released, the liquid will be drawn into the internal compartment 206 due to the resulting vacuum and suction effect. The child may lift the doll 102 from the liquid and compress the doll 102, decreasing the volume of the internal compartment 206, and thus forcing the liquid back out through aperture 208. In an embodiment in which the aperture 208 is located at the bottom of the doll 102, the liquid released through the aperture will resemble urination. When a child positions the doll 102 roughly centered over the model toilet 104 while compressing the doll 102, the potty training system 100 will resemble urination into a toilet. It is contemplated that this repeated process will reinforce the association of urination with a toilet. The system provides a fun way to introduce potty training to a child and allows the child to actively participate in the process, creating a positive association with potty training. This positive association may help to alleviate the intimidation a child may feel with respect to an actual toilet and aid in the potty training process.

Turning now to FIGS. 4-9, a perspective view, side view, front view, back view, top view and bottom view, of a model toilet 104 are shown. In embodiments, the model toilet 104 is shaped similar to a functioning toilet and may be comprised of scaled models of several of the elements of a functioning toilet. As depicted in the perspective view of FIG. 4, the model toilet 104 can include a toilet seat 110 and a toilet bowl 108 with an interior 112. The toilet bowl can include an aperture 116 through which liquid can drain. In embodiments, the seat 110 is fixed to the toilet bowl 108 or removably attached to the toilet bowl 108. In other embodiments, the seat 110 can be hinged in the same manner as in a functional toilet. In an embodiment, the model toilet 104 can also include a hinged lid 114, which can include an aperture that allows the user to easily grip the lid 114 to raise and lower the lid 114. In other embodiments, the lid 114 is fixed in position.

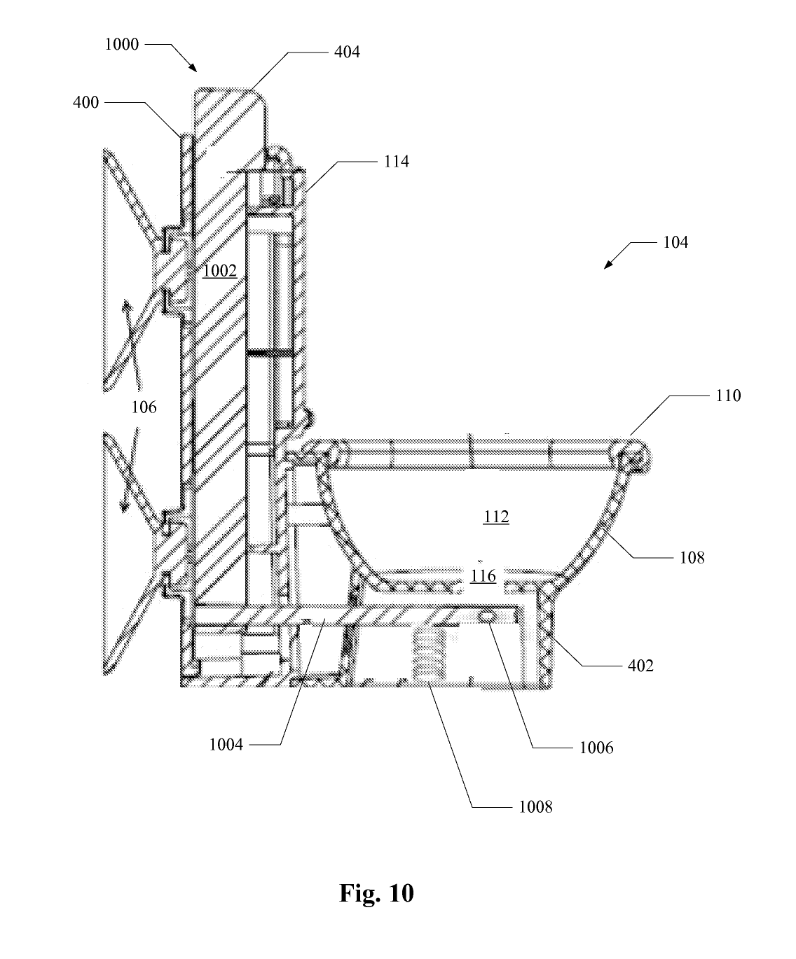

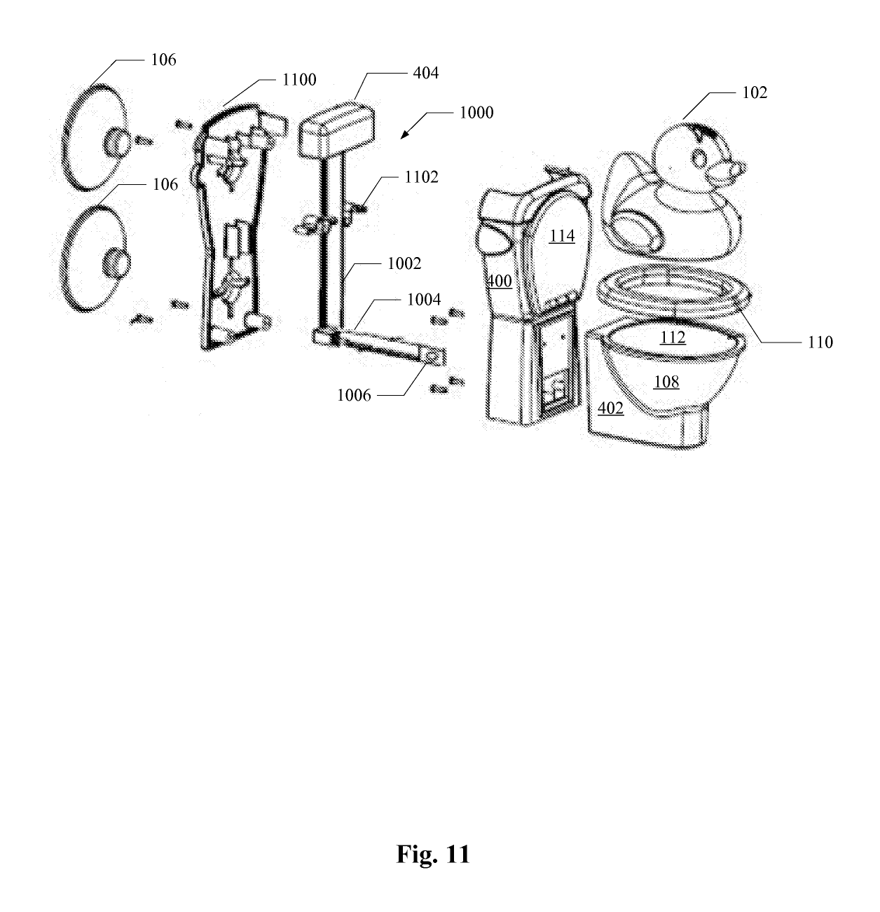

In embodiments, the model toilet 104 includes a back portion 400 and a base portion 402. As shown, the base portion 402 supports the toilet bowl 108 and connects the toilet bowl 108 to the back portion 400 of the model toilet 104. The back portion 400 and base portion 402 resemble parts of a functional toilet, assisting the child in connecting the model toilet 104 to a functional toilet. In addition, the back portion 400 and base portion 402 act as a cover for the mechanics of a model toilet 104. For example, the back portion 400 and base portion 402 encase the flushing mechanism 1000, as shown in FIGS. 10 and 11.

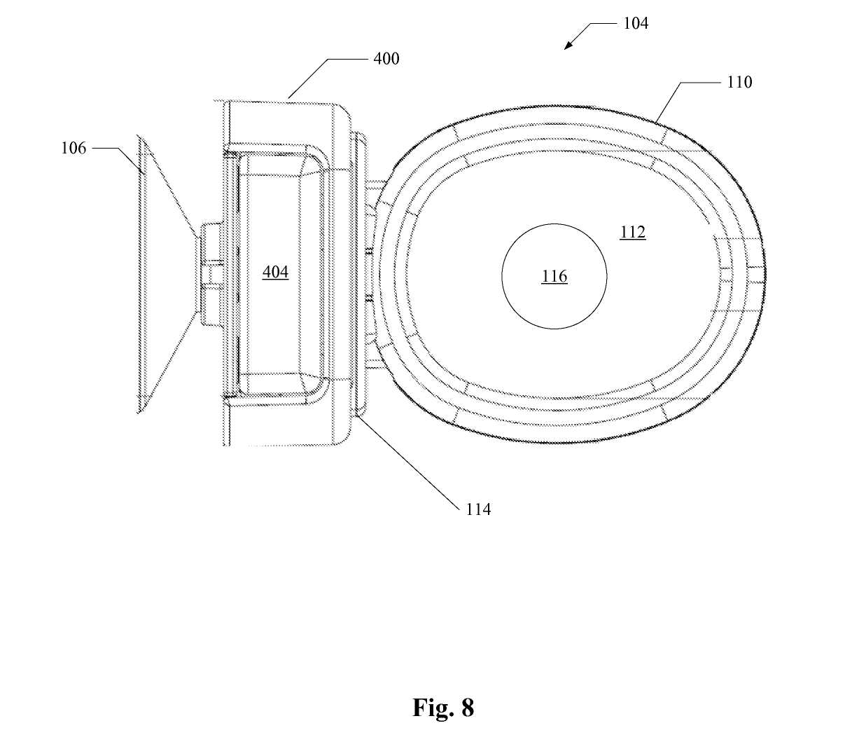

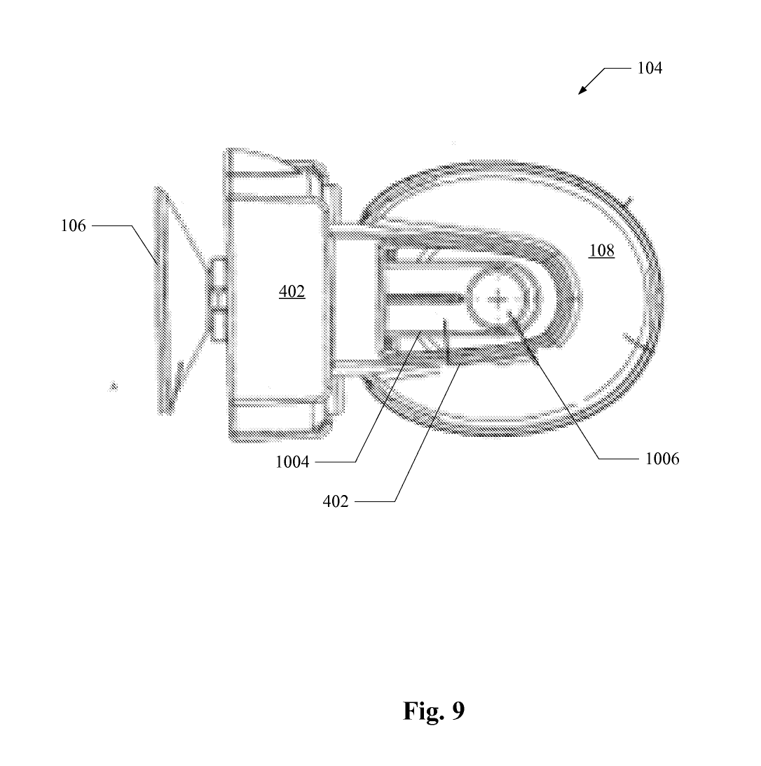

As can be seen in FIG. 4 and more clearly in FIG. 8, the interior 112 of the model toilet bowl 108 can include an aperture 116 through which liquid can drain from the model toilet 104. In some embodiments, the aperture 116 is left open to allow the liquid to drain freely from the toilet bowl 108. In other embodiments, a flushing mechanism 1000 includes a valve 1006 (shown in FIG. 10) that seals the aperture 116, where the child can flush the model toilet 104 by pushing the button and opening the valve 1006 in the bottom of the interior 112 of the toilet bowl 108. The flushing mechanism 1000 is described in greater detail below with respect to FIGS. 9 and 10.

In embodiments, the back portion 400 can be similar in appearance to a functioning toilet, but does not necessarily function in a similar manner. For example, in embodiments the back portion 400 does not operate as a holding tank for water used in flushing the toilet. Instead, the back portion 400 provides a cover for the moving parts of the flushing mechanism 1000, illustrated in the FIGS. 10 and 11, protecting the flushing mechanism 1000 from damage. Additionally, the back portion 400 can be shaped generally to model the tank of a toilet, assisting the child in associating play and operations of the model toilet 104 and an actual working toilet. Similarly, the model toilet 104 can include a base portion 402 that supports the toilet bowl 108 and connects to the back portion 400. The model toilet 104 may be proportionally sized to a common functional toilet. However, it is understood that the model toilet 104 may take any size, shape, and proportions. For example, the model toilet 104 can be shaped, sized and colored to appeal to a child, introducing the child to the concept of the toilet, but simplified for manufacturing purposes and for use by a small child.

In embodiments, the model toilet 104 features a button 404 that operates the flushing mechanism 1000. The button 404 can be located on the top of the back portion 400 connected to a valve that controls draining of the toilet bowl 108. In embodiments, the button 404 is designed to be easily used by the tiny, weak hands of a small child. In embodiments, the button 404 is large and takes up most of the top of the back portion 400. The button 404 can be large and brightly colored to encourage the child to press the button 404 and operate the flushing mechanism 1000. Depression of the button 404 can also trigger audio and/or visual stimuli intended to encourage and reward the child for using the model toilet 104.

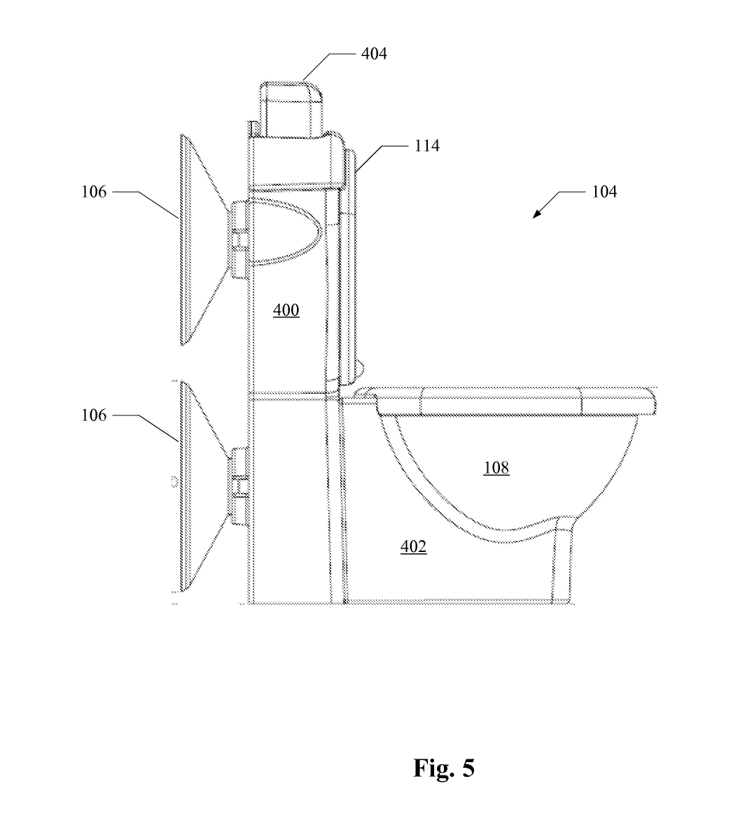

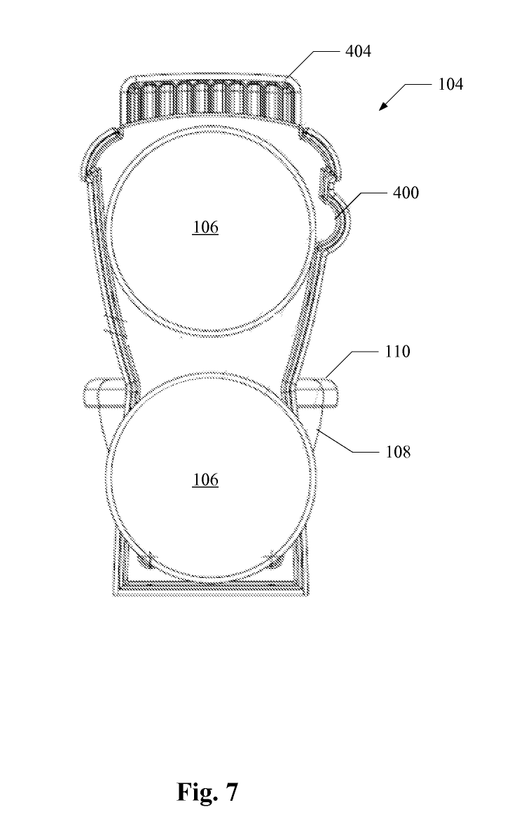

As can be seen in FIGS. 5 and 7, embodiments of the model toilet 104 include two suction cups 106 attached to the back of the toilet tank 400. The suction cups 106 can be attached via any suitable means. When the suction cups 106 are positioned on the back of the toilet tank 400, the model toilet can be attached to a surface via the suction cups 106 by pressing the suction cups 106 against the surface. The model toilet 104 then extends out from the surface, with the button 404 and toilet bowl 108 in easy reach of a child user.

The suction cups 106 can be a circular shape and of a diameter capable of creating suction force strong enough to support the model toilet 104. However, it is understood that the suction cups 106 can take any shape and size capable of creating the suction effect. Generally, suction cups rely on negative fluid pressure to adhere to nonporous surfaces, such as bathroom tile or bathtubs. The suction cups 106 are made from a flexible material, such as silicone or rubber and have a curved surface. When the center of the suction cup 106 is pressed against a surface, the suction cup 106 flexes, expelling air and the volume of space between the surface and the interior of the suction cup 106 decreases. When the center of the suction cup 106 is released, or no longer pressed, the suction cup 106 returns to its original shape, increasing the volume of space between the surface and the suction cup 106. The resulting difference in pressure keeps the suction cup 106 adhered to the surface. When air leaks back into the volume, or the seal is broken allowing air to enter the volume, the suction cup 106 no longer adheres to the surface. The result is that the suction cup 106 allows the model toilet to be removably adhered to a variety of generally non-porous surfaces, including but not limited to, mirrors, tile, and bathtubs. The model toilet 104 can be easily removed generally without damaging the surface to which it was adhered.

While two suction cups 106 are shown, a single suction cup 106 may be sufficient to support the model toilet 104, and any number or configuration of suction cups suitable to support the model toilet 104 can be used. In other embodiments, a method other than suction cups 106 is used for support. For example, a simple hook or strip of Velcro can be used to support the model toilet 104.

The suction cups 106 may be used to temporarily affix the model toilet 104 to a surface. In one embodiment, the model toilet 104 may be temporarily affixed to a vertical, tiled wall adjacent to a bathtub or shower, or to the bathtub or shower itself. This may be accomplished by simply pressing the suction cups 106 of the model toilet 104 against the wall. With the model toilet 104 temporarily affixed to the wall, the child will have the freedom to use both hands to compress the doll 102. Using both hands may be advantageous considering children lack strength and motor abilities. Additionally, the use of both hands may allow the child to better maneuver the doll 102 from the water to the model toilet 104. In other embodiments, the model toilet 104 may be temporarily affixed via suction cups 106 to a surface, for example a mirror or wall near a sink. Alternatively, the potty training system 100 may be used without affixing the model toilet 104 to any surface. In another embodiment, the model toilet 104 can include a hook or loop or molded fitting, such that the model toilet 104 can be attached to a faucet, handle, spout or other convenient fixture to hold the model toilet 104 generally in place.

In other embodiments, the model toilet 104 can be constructed to float. For example, the model toilet can be formed from a buoyant material and/or shaped to balance and float in liquid. In another embodiment, the model toilet 104 can be attached to a raft that allows the model toilet 104 to float in a bathtub or other bodies of water. In a further embodiment, the model toilet 104 can be attached to a floating ring. For example, a ring of Styrofoam or other buoyant material can be shaped like a life preserver, or other playful shape, and the model toilet 104 can be attached to this material such that the model toilet 104 floats in the bathtub or body of water.

Referring now to FIG. 10, a side view depicting an embodiment of the model toilet 104 illustrating a flushing mechanism 1000 is shown. The flushing mechanism 1000 is comprised of a button 404 seated on top of a substantially vertically-oriented rod 1002, which is attached to a generally horizontally-oriented stem 1004. The stem is connected to a valve 1006. In an embodiment, the valve 1006 is generally hemispherical in shape, so that when the valve 1006 is closed it is seated in the aperture 116 at the bottom of the toilet bowl 108, which allows the toilet bowl 108 to retain liquid. Upon opening the valve 1006, liquid in the toilet bowl 108 will drain through the aperture 116 into the base portion 402. In embodiments, the bottom of the base portion 402 is open allowing the liquid to drain out of the model toilet 104, as shown in the bottom view in FIG. 9. The draining of the liquid upon pressing the button will likely entertain a small child, encouraging interaction with the model toilet 104, and eventually with a functional toilet.

In other embodiments, the valve 1006 is a pad or protrusion that mates with the aperture 116, generally forming a seal to retain liquid in the toilet bowl 108. The valve can be formed from an elastic material, including but not limited to silicone or rubber, to better form a seal against the aperture 116. It is not required that the valve form a complete seal.

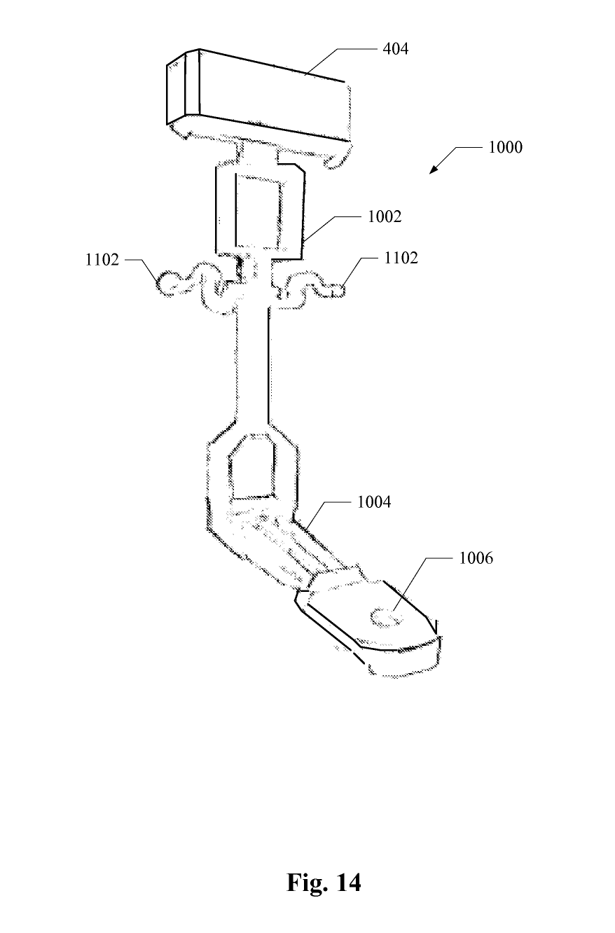

The flushing mechanism 1000 also features one or more arms 1102, shown in the exploded view in FIG. 11 and in detail in FIG. 14, which hold the flushing mechanism 1000, including button 404 and valve 1006 in place within the back portion 400 and base portion 402 of the model toilet 104. The arms 1102 can be shaped to be seated on one or more protrusions within the body of the back portion 400. In embodiments, the arms 1102 flex allowing the flushing mechanism 1000 to move when the button 404 is pushed and then return the flushing mechanism 1000 to its original position when the button 404 is released.

Referring once again to FIG. 10, the flushing mechanism can include one or more springs 1008 that bias the valve 1006, holding the valve 1006 in place against the aperture 116 of the toilet bowl 108 unless pressure is applied via the button 404. This pressure from pressing the button 404 forces the valve 1006 open from the aperture 116. The springs 1008 create a seal between the toilet aperture 116 and flushing mechanism valve 1006, until a downward force is applied to the button 404 by the user.

In embodiments, the flushing mechanism 1000 is contained within the model toilet shell, formed from the back portion 400 and base portion 402, and oriented for front-facing symmetry. The flushing mechanism 1000 is enclosed within the model toilet 104 to prevent injuries to a child such as pinched fingers as well as preventing interference with or breakage of the mechanism 1000. In some embodiments, the only exposed element of the flushing mechanism 1000 is the button 404. It is understood that the flushing mechanism 1000 may be constructed of any suitable material known in the art.

In embodiments, the flushing mechanism 1000 utilizes a diaphragm-type, convex-side-up valve 1006. The valve seal is maintained by the (spring constant) force of the springs 1008, connected to the horizontally-oriented stem 1004. When the button 404 is depressed, the connection of the rod 1002 to the stem 1004 causes the valve 1006 to be lowered at a about a 1:1 rate to the depression of the button 404. This breaks the valve seal and allows the contents of the toilet bowl 108 to drain out of the model toilet 104. The restoring force of the springs 1008 causes the flushing mechanism 1000 and valve 1006 to rise and restore the valve seal when the button 404 is released, allowing the toilet bowl 108 to be refilled. It is understood that the valve 1006 may take any suitable shape, including the aforementioned diaphragm shape, a ball valve, or any other suitable valve. In embodiments, the valve can be formed from rubber, silicone, or other materials capable of forming a seal.

Referring to FIG. 11, an assembly of the model toilet 104 and potty training system 100 is illustrated. As shown, a number of suction cups 106 are attached to a back plate 1100 of a back portion 400 of a model toilet 104. Any suitable means for attaching the suction cups 106 to the back plate 1100 can be used. The back plate 1100 is shaped to form the back of the back portion 400 and to support the flushing mechanism 1000 of the model toilet 104. In particular, the back plate 1100 can include one or more protrusions that support the arms 1102 of the flushing mechanism 1000.

In embodiments, the flushing mechanism 1000 is seated within the back portion 400 with only the button 404 exposed to the user. In embodiments, the back plate 1100 is secured to the back portion 400 with one or more screws to encase the flushing mechanism. The back portion 400 can include an attached lid 114 and can be connected to a base portion 402. The base portion 402 is connected to a toilet bowl 108 with toilet seat 110. As shown, the doll 102 can be sized to fit well with the model toilet 104 to encourage the child to use the potty training system 100.

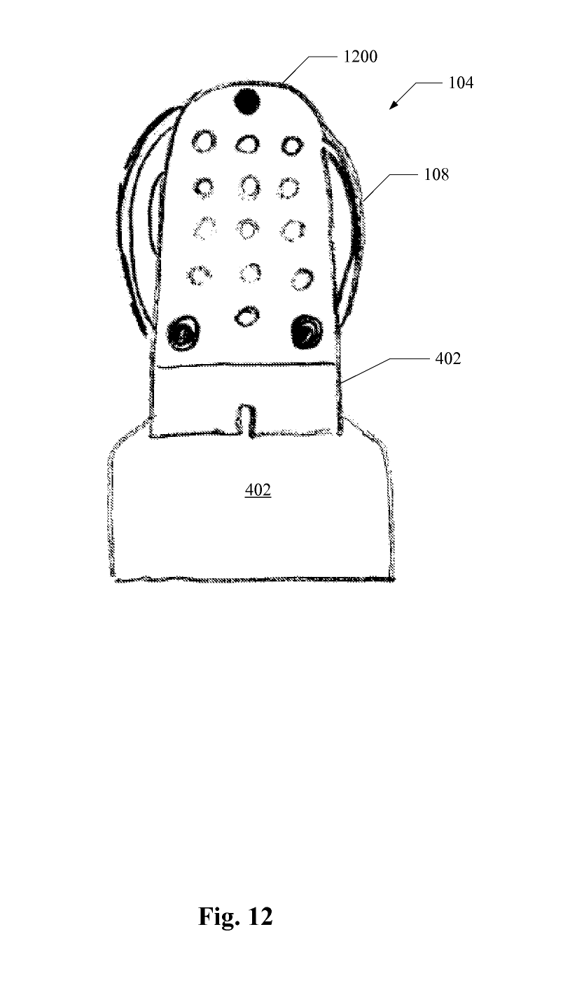

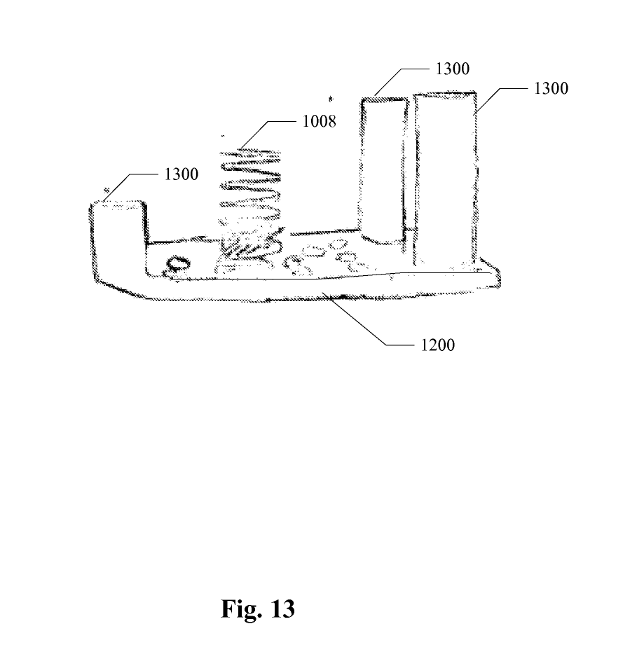

Turning now to FIGS. 12 and 13, in embodiments, a protective plate or screen 1200 covers at least a portion of the bottom of the base portion 402 of the model toilet 104. As shown, in FIG. 12, the screen 1200 is attached to at least a portion of the bottom of the base portion 402 and is positioned below the aperture 116, stem 1004 and valve 1006. As shown, the screen 1200 includes one or more holes that allow the liquid released from the toilet bowl 108 to drain from the model toilet 104. However, the apertures are small enough to prevent children's fingers from poking through the screen and interfering with the flushing mechanism 1000. The screen 1200 can be attached to the bottom of the model toilet 104 using screws, pins or any other suitable attachment mechanism.

FIG. 13 depicts the screen 1200 independent of the model toilet 104. As shown, the screen 1200 can include one or more screw sleeves 1300 that facilitate attaching the screen 1200 to the bottom of the model toilet 104. In addition, one or more springs 1008 can be seated on the screen 1200. This spring or springs can press against the stem 1004 and bias the valve 1006 against the aperture 116, holding the valve 1006 closed and sealing the aperture 116 in the toilet bowl 108.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

What is claimed is:

1. A model toilet for use in potty training, comprising:
a model toilet bowl having an aperture at about the bottom of the bowl;
a flushing mechanism that comprises:
a valve that seals the aperture of the model toilet bowl;
a button functionally connected to the valve; wherein pressure applied to the button is directed to open the valve;
a shell that supports the model toilet bowl and covers at least a portion of the flushing mechanism; and
at least one suction cup connected to the shell that removably attaches to a surface to suspend the model toilet.

2. The model toilet of claim 1, wherein the shell comprises a back portion that generally models the shape of a tank of a functional toilet; and a base portion that supports the model toilet bowl and connects to the back portion.

3. The model toilet of claim 2, wherein at least a portion of the base portion is open at the bottom to allow liquid to drain from the model toilet bowl through the aperture and through the base portion out of the model toilet.

4. The model toilet of claim 1, wherein the flushing mechanism further comprises:
a rod connected to the button that is substantially vertically-oriented in the shell; and
a stem that connects the rod to the valve, wherein the stem is substantially horizontally-oriented.

5. The model toilet of claim 4, where the rod includes at least one flexible arm that supports the rod within the shell, wherein pressure on the button causes the arm to flex and release of the button allows the arm to return to its initial position.

6. The model toilet of claim 4, wherein pressure on the button causes the rod to move vertically in the shell, which causes the stem to lower, opening the valve and releasing liquid retained within the model toilet bowl.

7. The model toilet of claim 1, wherein at least a portion of the valve is substantially hemispherical and formed from an elastic material.

8. The model toilet of claim 1, further comprising a screen attached to the bottom of the shell, generally below the valve and the aperture of the model toilet bowl wherein the screen includes at least one screen aperture sized to prevent children's fingers from passing through the screen.

9. The model toilet of claim 8, further comprising a spring attached to the screen and abutting the stem, wherein the spring biases the valve to keep the aperture of the model toilet bowl sealed.

10. A potty training system, comprising:
a model toilet, comprising:
a model toilet bowl having an aperture at about the bottom of the bowl;
a flushing mechanism that comprises:
a valve that seals the aperture of the model toilet bowl;
a button functionally connected to the valve; wherein pressure applied to the button is directed to open the valve; and
a shell that supports the model toilet bowl and covers at least a portion of the flushing mechanism; and
a doll, sized and shaped for use with the model toilet, wherein the doll is adapted to simulate urination by squirting liquid into the model toilet, and the flushing mechanism operates to drain the liquid from the model toilet bowl and out the bottom of the model toilet.

11. The model toilet of claim 10, wherein the shell comprises a back portion that generally models the shape of a tank of a functional toilet; and a base portion that supports the model toilet bowl and connects to the back portion.

12. The model toilet of claim 11, wherein at least a portion of the base portion is open at the bottom to allow liquid to drain from the model toilet bowl through the aperture and through the base portion out of the model toilet.

13. The model toilet of claim 10, wherein the flushing mechanism further comprises:
a rod connected to the button that is substantially vertically-oriented in the shell; and
a stem that connects the stem to the valve, wherein the stem is substantially horizontally-oriented.

14. The model toilet of claim 13, where the rod includes at least one flexible arm that supports the rod within the shell, wherein pressure on the button causes the arm to flex and release of the button allows the arm to return to its initial position.

15. The model toilet of claim 13, wherein pressure on the button causes the rod to move vertically in the shell, which causes the stem to lower, opening the valve and releasing liquid retained within the model toilet bowl.

16. The model toilet of claim 10, wherein at least a portion of the valve is substantially hemispherical and formed from an elastic material.

17. The model toilet of claim 10, further comprising a screen attached to the bottom of the shell, generally below the valve and the aperture of the model toilet bowl, wherein the screen includes at least one screen aperture sized to prevent children's fingers from passing through the screen.

18. The model toilet of claim 17, further comprising a spring attached to the screen and abutting the stem, wherein the spring biases the valve to keep the aperture of the model toilet bowl sealed.

19. The model toilet of claim 10, further comprising a model toilet seat and a model lid, wherein the model toilet seat and model lid are hinged.

20. A potty training system, comprising:
a model toilet, comprising:
a model toilet bowl having an aperture at about the bottom of the bowl;
a flushing mechanism that comprises:
a valve that seals the aperture of the model toilet bowl;
a button functionally connected to the valve; wherein pressure applied to the button is directed to open the valve;
a shell that supports the model toilet bowl and covers at least a portion of the flushing mechanism, wherein the shell comprises a back portion that generally models a tank of a functional toilet and a base portion that supports the model toilet bowl and connects to the back portion; and
at least one suction cup connected to the shell that removably attaches to a surface to suspend the model toilet; and
a doll, sized and shaped for use with the model toilet, wherein the doll is adapted to simulate urination by squirting liquid into the model toilet, and the flushing mechanism operates to drain the liquid from the model toilet bowl.
